(19) United States
(12) Patent Application Publication
(10) Pub. No.: US 2019/0217330 A1
(43) Pub. Date: Jul. 18, 2019

(54) GLUE GUN DEVICE

(71) Applicant: Yimin ZHU, Chongqing (CN)

(72) Inventor: Yimin ZHU, Chongqing (CN)

(21) Appl. No.: 16/208,195

(22) Filed: Dec. 3, 2018

(30) Foreign Application Priority Data
Jan. 15, 2018 (CN) 201810035148.7
Jan. 15, 2018 (CN) 201820061066.5

(51) Int. Cl. B05C 17/01; F16H 7/18; F16H 7/06; F16G 13/07

(52) U.S. Cl. CPC B05C 17/0116; F16H 7/18; F16H 1/14; F16G 13/07; F16H 7/06

(57) ABSTRACT

A glue gun device includes a barrel for receiving a fluid material therein, an outer casing connected with a driving end of the barrel to receive a driving unit, a pressing unit disposed in the barrel and including a pressing member that is movable to expel the fluid material out of a nozzle end, and a transmission chain that is connected to the pressing member to be operable to move the pressing member. The transmission chain is configured to extend from a leading end rearwardly, be deflected downwardly at the driving end, and extend forwardly to terminate at a trailing end to define a chain moving track along an extension path of the transmission chain. A drive transmission unit is disposed at the driving end to transmit a drive from the driving unit to the transmission chain to move the transmission chain along the chain moving track.

### CROSS-REFERENCE TO RELATED APPLICATION

This application claims priorities of Chinese Patent Application No. 201810035148.7, filed on Jan. 15, 2018, and of Chinese Patent Application No. 201820061066.5, filed on Jan. 15, 2018.

### FIELD

The disclosure relates to a glue gun device, and more particularly to a glue gun device with a transmission chain received in a barrel to expel a fluid material out of the barrel.

### BACKGROUND

Glue guns are well known in the art. Referring to FIG. 1, a conventional clue gun 9 generally includes a barrel 91 for receiving a fluid material (not shown), a nozzle 92 removably mounted on a nozzle end 911 of the barrel 91, an outer casing 93, a motor (not shown) disposed within the outer casing 93, a trigger 94 electrically connected with the motor, and a press rack 95 driven by the motor to move a pressing member (not shown) in the barrel 91. Before operation, the nozzle 92 is removed from the barrel 91 to have a fluid material filled in the barrel 91. When a pressure is applied on the trigger 94 to actuate the motor, the press rack 95 is moved forward toward the nozzle end 911 so as to expel the fluid material out from the nozzle 92. However, since the press rack 95 has a portion elongated and projecting out of a rear end of the barrel 91, it is inconvenient to use the conventional glue gun 9 in a narrow place.

### SUMMARY

Therefore, an object of the disclosure is to provide a glue gun device that can alleviate at least one of the drawbacks of the prior art.

According to the disclosure, the glue gun device includes a barrel, an outer casing, a driving unit, a pressing unit and a drive transmission unit. The barrel has a barrel wall which defines a barrel space for receiving a fluid material, and which has a nozzle end and a driving end opposite to each other in an axial direction. The outer casing has a rear housing portion which is connected with and extends rearwardly from the driving end in the axial direction. The driving unit is disposed within the rear housing portion. The pressing unit is disposed in the barrel, and includes a pressing member which is movable relative to an inner barrel surface of the barrel wall in the axial direction to expel the fluid material out of the nozzle end, and a transmission chain which has a leading end that is connected to the pressing member to be operable to move the pressing member in the axial direction, and which is configured to extend from the leading end rearwardly and in the axial direction, be deflected downwardly at the driving end, and extend forwardly and in the axial direction to terminate at a trailing end, so as to define a chain moving track along an extension path of the transmission chain. The drive transmission unit is disposed at the driving end, and is coupled with the driving unit to transmit a drive from the driving unit to the transmission chain to move the transmission chain along the chain moving track toward the nozzle end.

### BRIEF DESCRIPTION OF THE DRAWINGS

Other features and advantages of the disclosure will become apparent in the following detailed description of the embodiments with reference to the accompanying drawings, of which:

FIG. 1 is a schematic side view of a conventional glue gun;

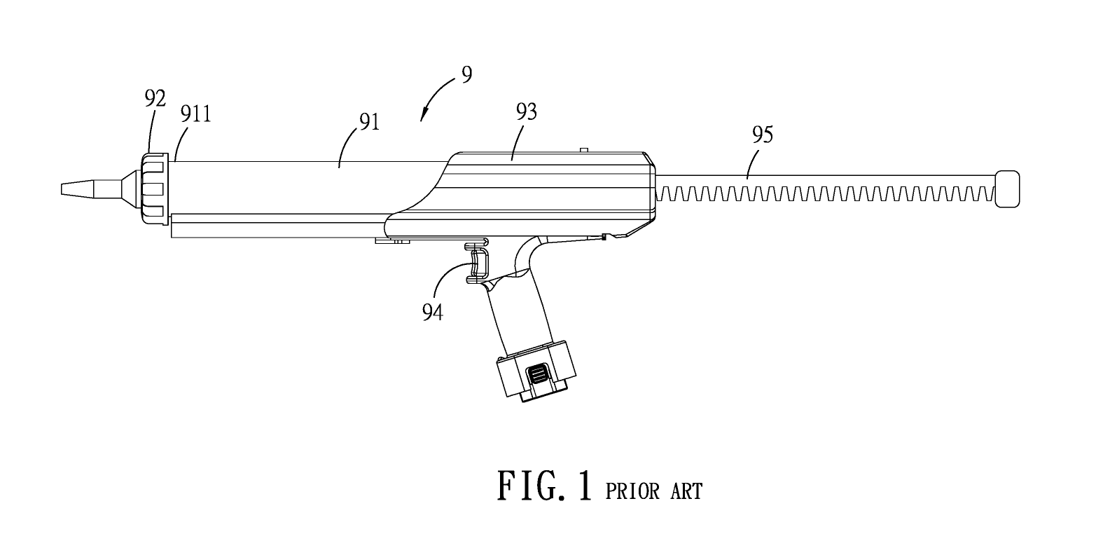

FIG. 2 is a perspective view illustrating a first embodiment of a glue gun device according to the disclosure;

FIG. 3 is a perspective view of the first embodiment, a portion of an outer casing thereof being removed for the sake of clarity;

FIG. 4 is a sectional view of the first embodiment;

FIG. 5 is a cross-sectional view of a barrel of the first embodiment;

FIG. 6 is a perspective view of a driving unit and a drive transmission unit according to the first embodiment, illustrating a state when a clutch mechanism of the drive transmission unit is in a disengaging position;

FIG. 7 is a perspective view similar to FIG. 6, illustrating a state when the clutch mechanism is in an engaging position;

FIG. 8 is a perspective view of a pressing unit of the first embodiment;

FIG. 9 is a fragmentary perspective view illustrating a second embodiment of a glue gun device according to the disclosure;

FIG. 10 is a fragmentary, exploded perspective view of the second embodiment;

FIG. 11 is a fragmentary, sectional view of the second embodiment, illustrating a state when a pressing unit is in a ready position; and

FIG. 12 is a view similar to FIG. 11, illustrating a state when the pressing unit is in a pressing position.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

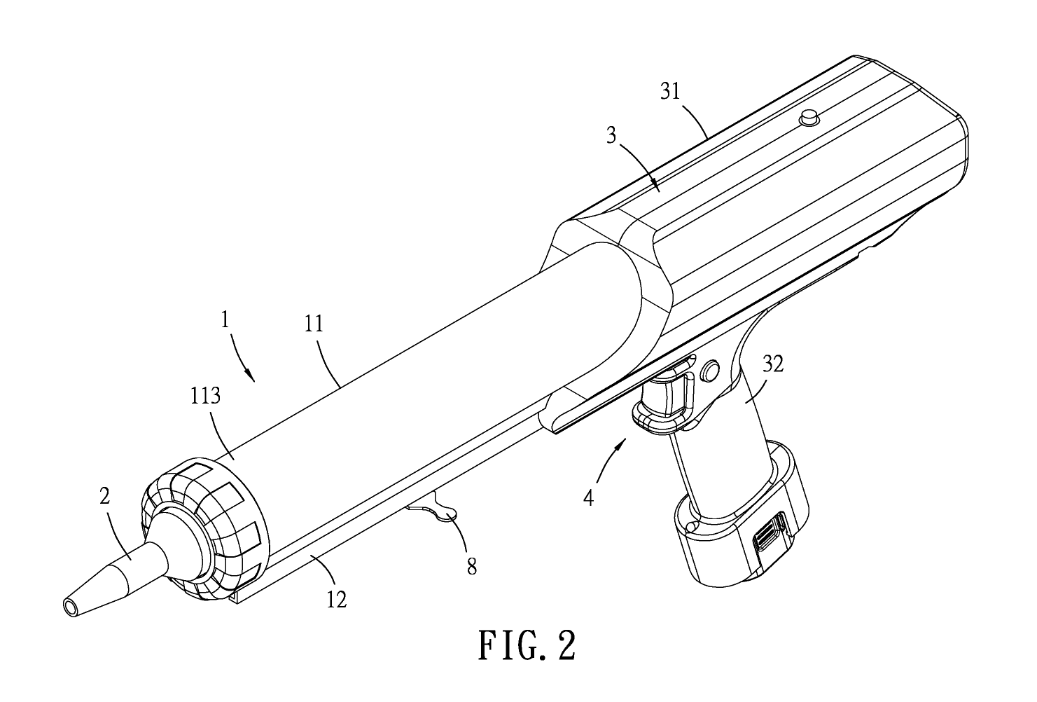

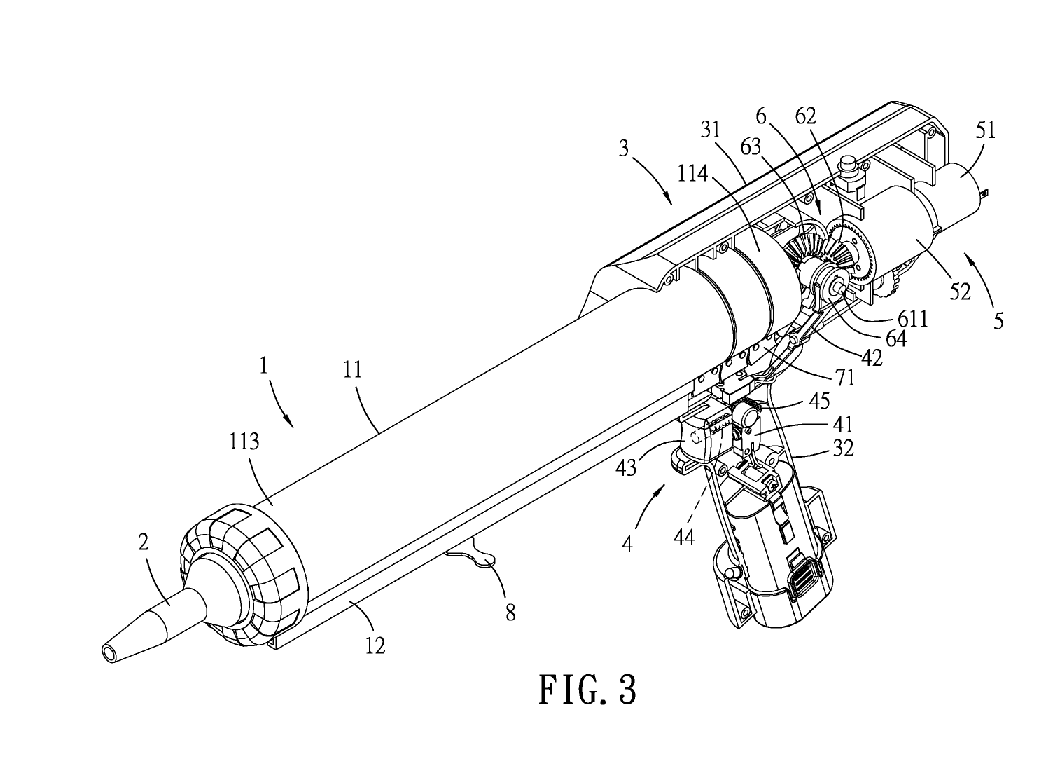

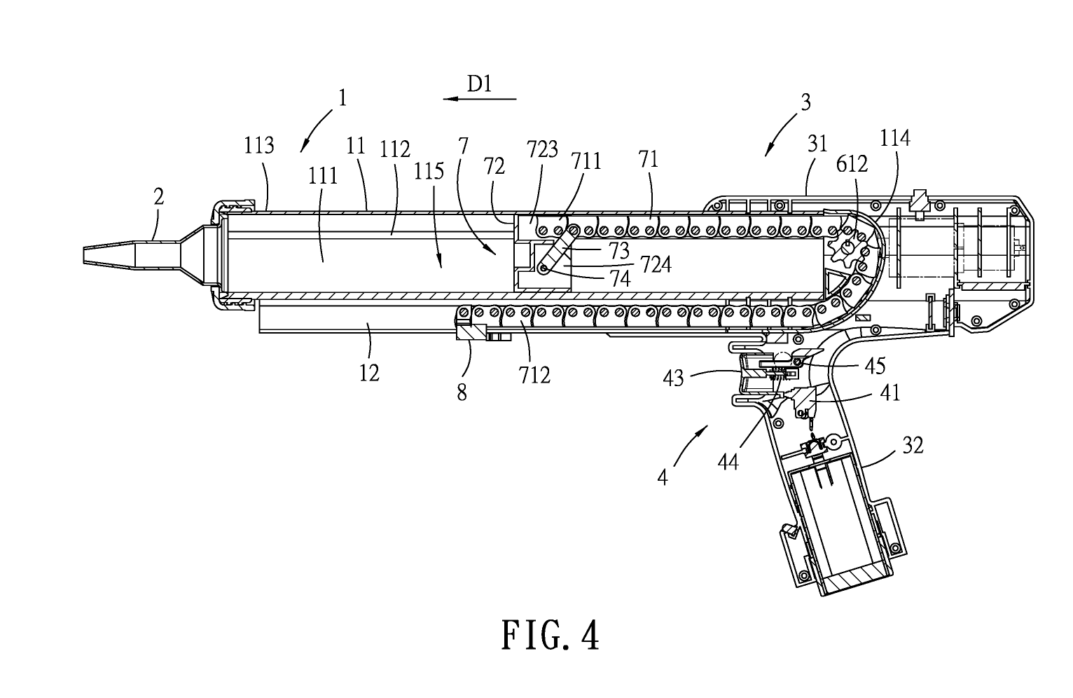

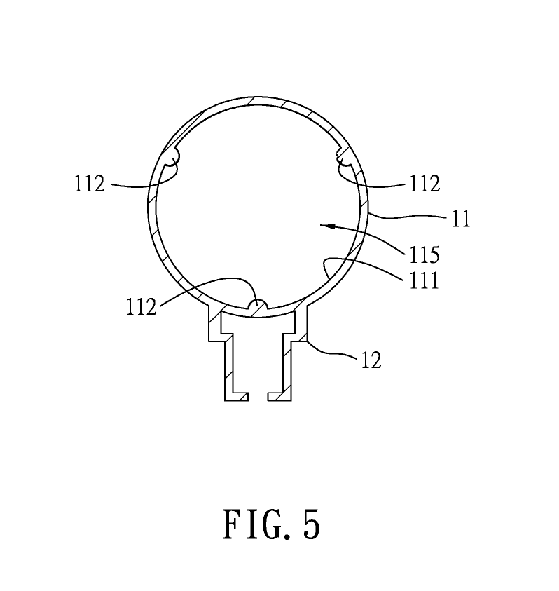

Referring to FIGS. 2 to 4, a first embodiment of a glue gun device according to the disclosure is used for dispensing a fluid material (not shown), such as caulking, a structural adhesive, a weatherproofing sealant, etc., to perform fastening, modeling, repairing, sealing and joining works. The glue gun device includes a barrel 1, a nozzle 2, an outer casing 3, a triggering unit 4, a driving unit 5, a drive transmission unit 6, a pressing unit 7 and a handle 8. The barrel 1 has a barrel wall 11 and a rail channel 12 formed on a lower side of the barrel wall 11. The barrel wall 11 has an inner barrel surface 111 which defines a barrel space 115 for receiving the fluid material, and a nozzle end 113 and a driving end 114 which are opposite to each other in an axial direction. A plurality of axially extending ridges 112 (see FIG. 5) (for example, three ridges 112) are disposed on the inner barrel surface 111 and angularly displaced from each other. The rail channel 12 extends forwardly and in the axial direction from the driving end 114. The nozzle 2 is removably mounted on the nozzle end 113. In this embodiment, the fluid material may be packaged by a squeezable bag (not shown) that is received in the barrel space 115 from the nozzle end 113 after the nozzle 2 is removed from the barrel wall 11 to have an opening of the squeezable bag facing forward at the nozzle end 113. A rear closed end of the squeezable bag is pressed and squeezed forward to expel the fluid material out of the nozzle end 113. Alternatively, the fluid material may be received in the barrel space 115 without the squeezable bag.

The outer casing 3 has a rear housing portion 31 which is sleeved on and extends rearwardly from the driving end 114 in the axial direction, and a handheld housing portion 32 which is connected with and extends downwardly from the rear housing portion 31.

The triggering unit 4 is disposed within the handheld housing portion 32, and includes a contact switch 41 which is electrically connected with the driving unit 5, an actuating arm 42 which extends from the handheld housing portion 32 to the driving end 114, a trigger 43 which is operable in a triggering stroke to two operating positions to respectively press the contact switch 41 and the actuating arm 42, a trigger returning member 44 which is disposed to return the trigger 43, and an arm returning member 45 which is connected to the actuating arm 42. In this embodiment, the trigger and arm returning members 44, 45 are biasing springs. The construction and operation of the triggering unit 4 will be described in detail as follows.

The driving unit 5 is disposed within the rear housing portion 31, and includes an electric motor 51 electrically connected with the contact switch 41, and a planetary gear reduction mechanism 52 for supplying a speed-reducing drive.

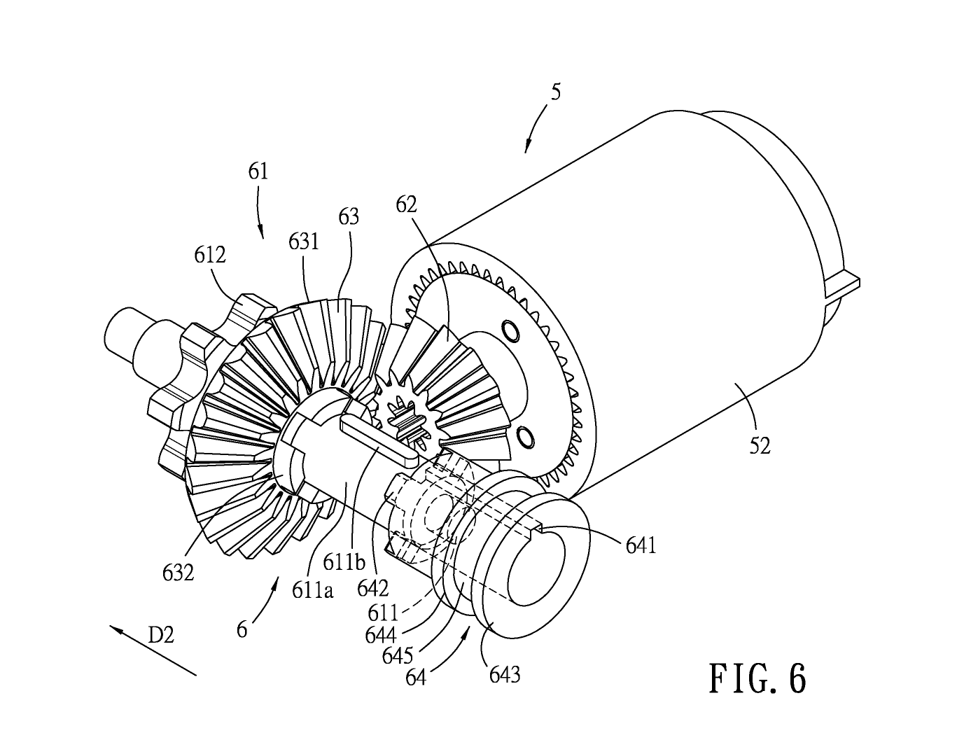

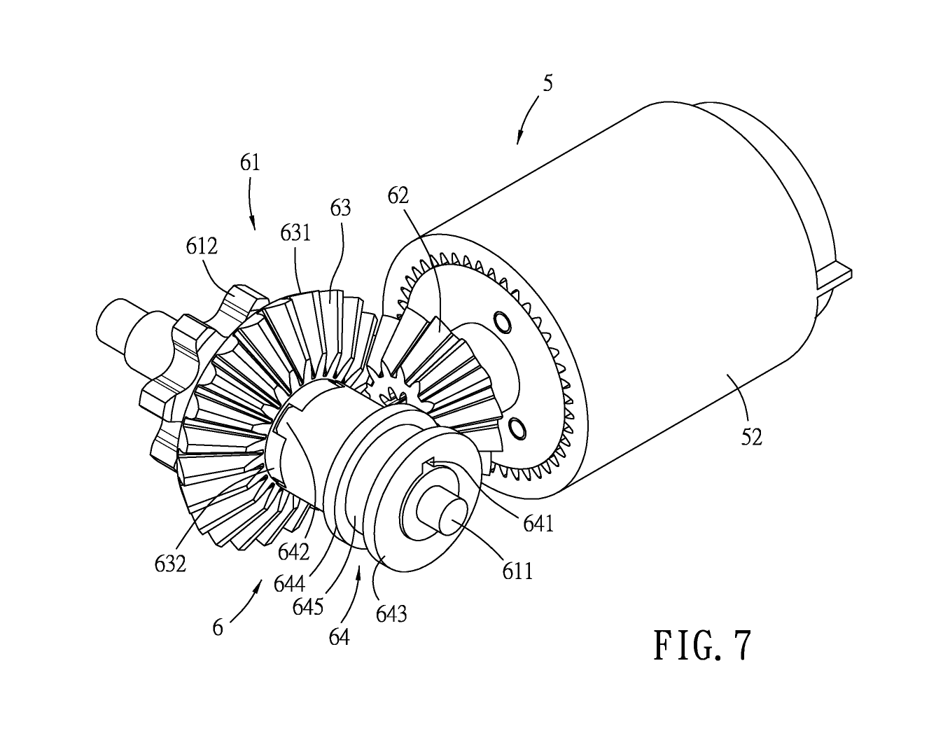

The drive transmission unit 6 is disposed at the driving end 114, and is driven by the drive from the driving unit 5 to move the pressing unit 7 for squeezing the fluid material. Specifically, with reference to FIGS. 6 and 7, the drive transmission unit 6 includes a chain wheel assembly 61 which is rotatable about a spindle axis that is transverse to the axial direction to move the pressing unit 7, a first gear 62 which is coupled to rotate with the driving unit 5, a second gear 63 which is rotatably mounted on the chain wheel assembly 61 about the spindle axis and meshes with the first gear 62, and a clutch mechanism 64 which is axially movably sleeved on the chain wheel assembly 61 and connected to the actuating arm 42. Specifically, in this embodiment, the chain wheel assembly 61 has a spindle 611 which extends along the spindle axis and on which the second gear 63 is rotatably sleeved, and a chain wheel 612 which is mounted on the spindle 611 in a press-fit manner and meshes with the pressing unit 7. The spindle 611 has a spindle body (611a) extending along the spindle axis, and an elongated key (611b) projecting from an outer surface of the spindle body (611a) and elongated in a direction transverse to the axial direction. The chain wheel 612 is sleeved on the spindle body (611a) to be rotated therewith. The first gear 62 is coupled with the planetary gear reduction mechanism 52 to transmit the speed-reducing drive to the second gear 63. In this embodiment, the first and second gears 62, 63 are bevel gears having their rotating axes perpendicular to each other. The second gear 63 has a gear portion 631 which is rotatably mounted on the spindle body (611a), and a first engaging portion 632 which extends from the gear portion 631 in the direction transverse to the axial direction toward the clutch mechanism 64. The clutch mechanism 64 is movably sleeved around the spindle 611, and has a keyway 641 configured to be engaged with the key (611b), a second engaging portion 642 disposed at a proximal end of the clutch mechanism 64 and configured to be engaged with the first engaging portion 632, a disengaging operated portion 643 disposed at a distal end of the clutch mechanism 64, and an engaging operated portion 644 spaced apart from the disengaging operated portion 643 by a connecting slot 645 for connecting the actuating arm 42 therein. Thus, the clutch mechanism 64 is operably movable along the spindle axis between an engaging position, where the keyway 641 and the second engaging portion 642 are configured to be respectively engaged with the key (611b) of the chain wheel assembly 61 and the first engaging portion 632 of the second gear 63 to permit transmission of the drive to rotate the chain wheel assembly 61, and a disengaging position, where the clutch mechanism 64 is disengaged from both the chain wheel assembly 61 and the second gear 63 to interrupt the transmission of the drive.

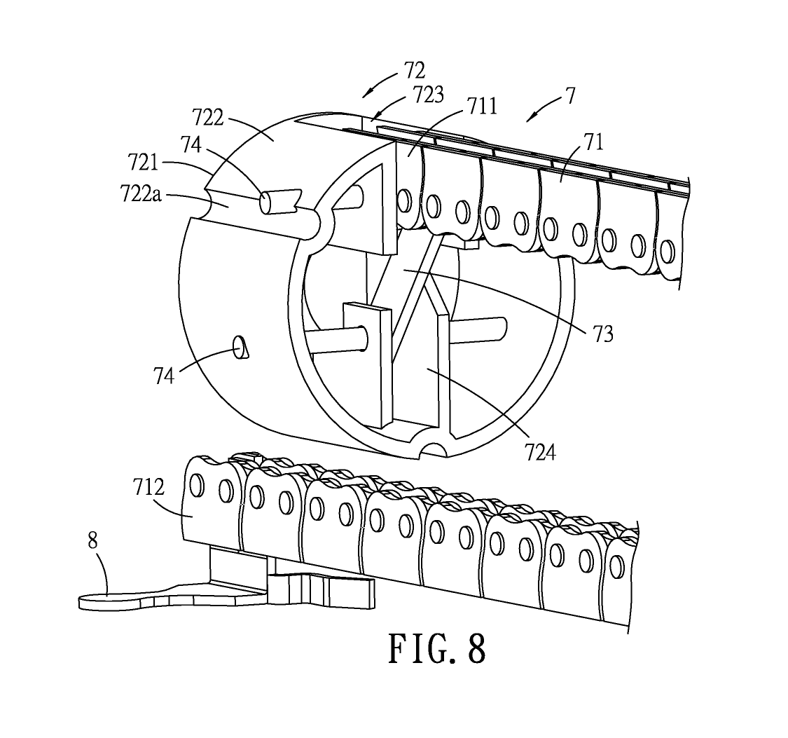

The pressing unit 7 is disposed in the barrel 1, and includes a pressing member 72 which is fittingly engaged with and slidable relative to the inner barrel surface 111 of the barrel wall 11 in the axial direction to expel the fluid material out of the nozzle end 113, and a transmission chain 71 which has a leading end 711 that is connected to the pressing member 72 to be operable to move the pressing member 72 in the axial direction, and which is configured to extend from the leading end 711 rearwardly and in the axial direction, be deflected downwardly at the driving end 114, and extend forwardly and in the axial direction to terminate at a trailing end 712, so as to define a chain moving track along an extension path of the transmission chain 71. In this embodiment, the transmission chain 71 is in the form of a unidirectional bending chain which is bent to match with the inner barrel surface 111 of the barrel wall 11 at the driving end 114, and in turn extends in and along the rail channel 12 so as to define a portion of the chain moving track by the rail channel 12. The chain wheel 612 meshes with the bending segment of the transmission chain 71 to transmit the drive to the transmission chain 71 to move the transmission chain 71 along the chain moving track toward the nozzle end 113. Hence, the transmission chain 71 is wholly accommodated in the barrel 1 without exposure from the outer casing 3. With reference to FIG. 8, the pressing member 72 has an end wall 721 which is disposed normal to the axial direction, a surrounding wall 722 which extends rearwardly and in the axial direction from a periphery of the end wall 721, a retaining notch 723 which is formed in the surrounding wall 722 and recessed toward the end wall 721 for retaining the leading end 711 of the transmission chain 71 therein, and a stabilizing portion 724 which is disposed on the end wall 721 and diametrically opposite to the retaining notch 723 and extends adjacent to a center line of the end wall 721. The surrounding wall 722 is configured to be fitted to the inner barrel surface 111 of the barrel wall 11 and in a spline engagement with the inner barrel surface 111 to prevent rotation of the pressing member 72 relative to the barrel wall 11. Specifically, the surrounding wall 722 has a plurality of grooves (722a) respectively engaged with the ridges 112 (see FIG. 5) of the inner barrel surface 111. The pressing unit 7 further includes two insert pins 74, one disposed to retain the leading end 711 to the retaining notch 723, and the other one disposed to connect a force dispersing member 73 to the stabilizing portion 724. The force dispersing member 73 interconnects the leading end 711 and the stabilizing portion 724 to disperse a force subjected to the retaining notch 723 throughout the end wall 721. The handle 8 is connected to the trailing end 712 and projects outwardly of the rail channel 12 to be manually operable to move the transmission chain 71 backwardly along the chain moving track so as to move the pressing member 72 toward the driving end 114.

When the trigger 43 is pulled in a triggering stroke to a first operating position, the trigger 43 presses the contact switch 41 to activate the electric motor 51 such that a speed-reducing drive is transmitted through the planetary gear reduction mechanism 52 to rotate the first gear 62 and the second gear 63. At this stage, the trigger 43 does not press the actuating arm 42 and the actuating arm 42 is in abutment with the disengaging operated portion 643 so as to keep the clutch mechanism 64 in the disengaging position away from the second gear 63. The second gear 63 is in an idling motion. When the trigger 43 is further pulled to a second operating position, the trigger 43 presses and moves the actuating arm 42 to abut against and urge the engaging operated portion 644 so as to move the clutch mechanism 64 in an engaging direction (D2) to the engaging position, where the keyway 641 and the second engaging portion 642 are respectively engaged with the key (611b) and the first engaging portion 632. The drive is transmitted to rotate the chain wheel assembly 61, and the transmission chain 71 is moved thereby along the chain moving track in an expelling direction (D1) so as to expel the fluid material out of the nozzle end 113 through the nozzle 2.

In this embodiment, the transmission chain 71 is a unidirectional bending chain which is bent toward either side in a single direction, and undesired deformation of the transmission chain 71 is hence avoided during the use of the glue gun device. Additionally, the transmission chain 71 can be kept spaced apart from the inner barrel surface 111 of the barrel wall 11 to prevent frictional contact with the barrel wall 11. Moreover, with the spline engagement of the ridges 112 with the grooves (722a), rotation of the pressing member 72 relative to the barrel 1 is prevented during the pressed movement of the pressing unit 7 so as to successfully and evenly squeeze the fluid material out of the barrel 1. Through the force dispersing member 73 which interconnects the leading end 711 and the stabilizing portion 724, a force subjected to the retaining notch 723 can be dispersed throughout the end wall 721 so as to further facilitate evenly expelling the fluid material. With the insert pins 74 disposed to retain the transmission chain 7 and the force dispersing member 73 to the pressing member 72, an undesired deflection of the pressing member 72 from the expelling direction (D1) can be further avoided. When the force on the trigger 43 is released, the trigger 43 is returned by means of the trigger returning member 44, and the actuating arm 42 is returned by means of the arm returning member 45 to abut against and move the disengaging operated portion 643 to the disengaging position for interrupting the drive transmission so that the chain wheel assembly 61 is stopped from rotation to stop the movement of the pressing unit 7. At this moment, the internal pressure of the barrel space 115 is released toward the driving end 114 to generate a force that urges the pressing unit 7 and the fluid material backward toward the driving end 114 to minimize outflow of the fluid material from the nozzle 2. When the fluid material is entirely expelled, the handle 8 can be manually operated to move the transmission chain 71 backwardly opposite to the expelling direction (D1) along the chain moving track so as to move the pressing member 72 toward the driving end 114.

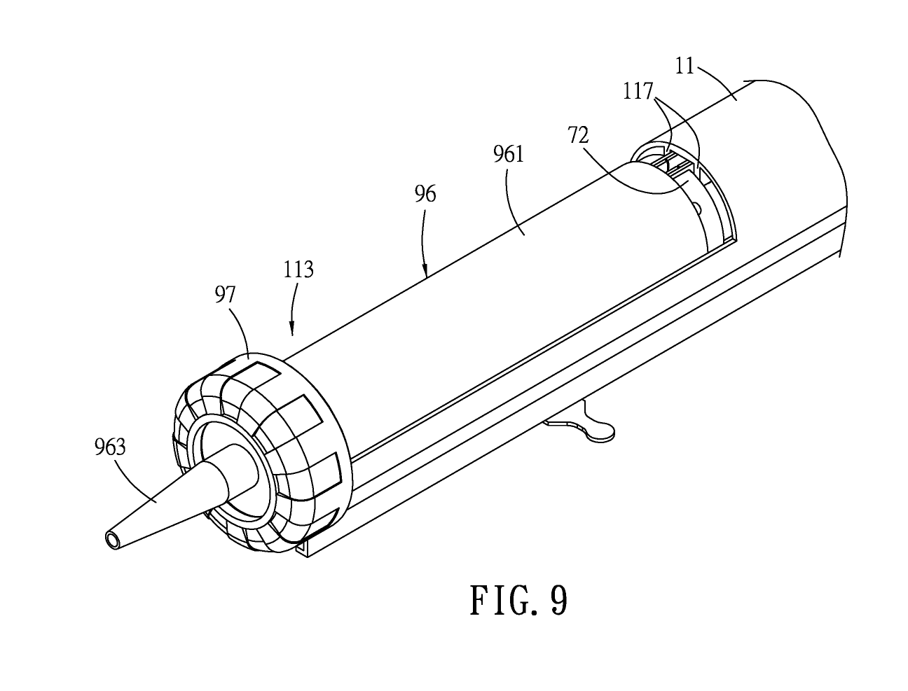

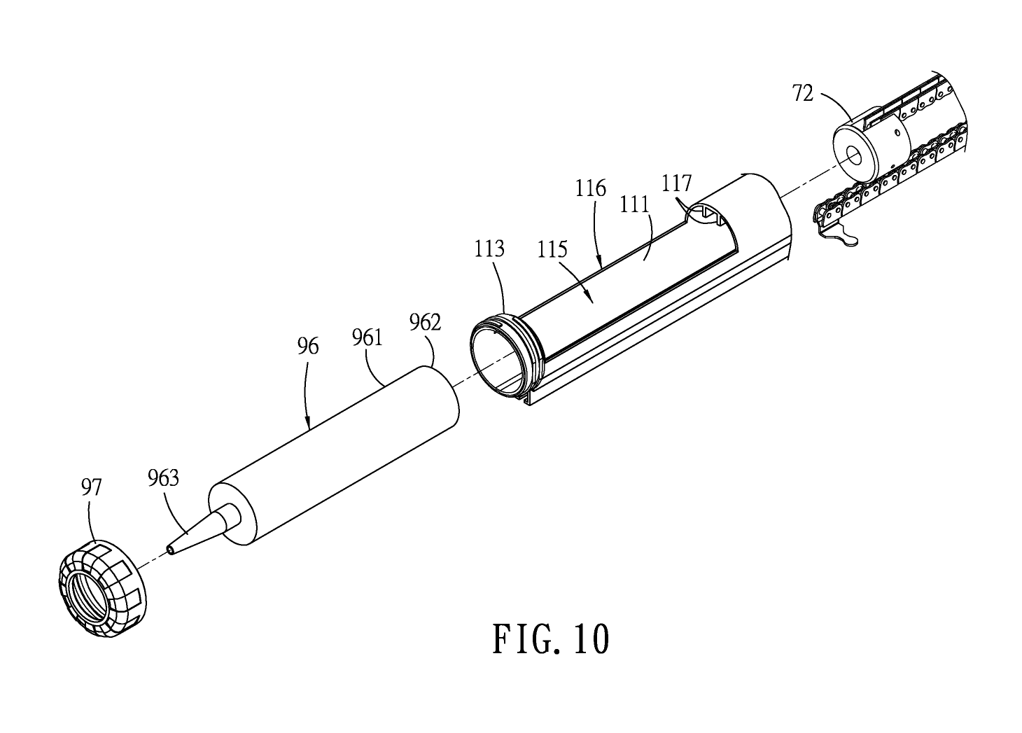

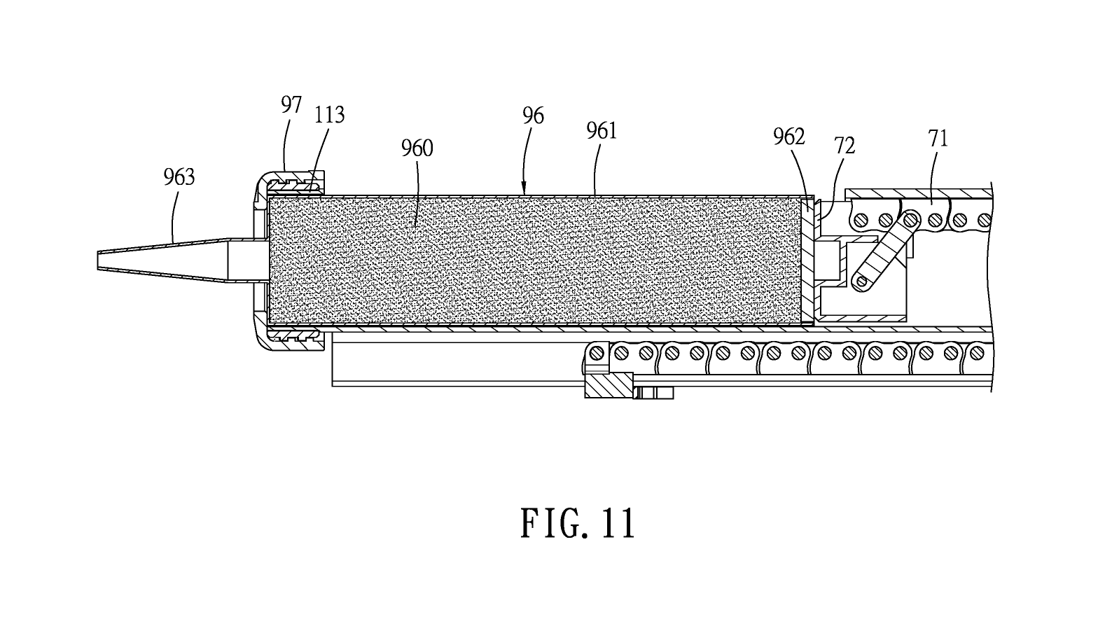

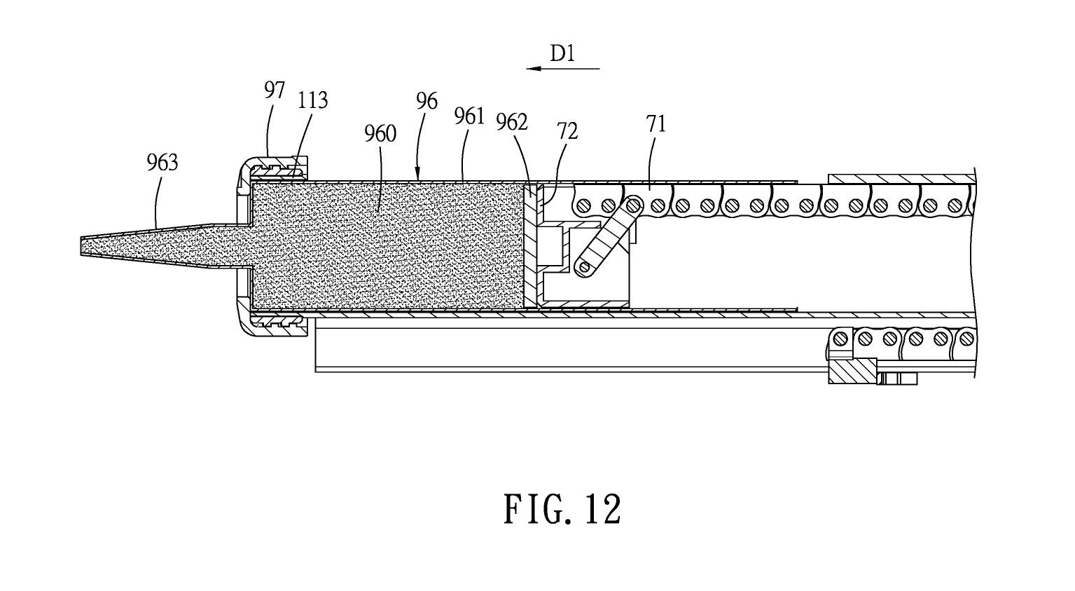

Referring to FIGS. 9 to 12, in a second embodiment, the fluid material 960 (see FIG. 11) is pre-filled in a rigid tube 96 that is accommodated in the barrel space 115 of the barrel 1. The rigid tube 96 has a tubular wall 961, a base seat 962 which is mounted on and axially movable relative to a rear end of the tubular wall 961, and a nozzle 963 mounted on a front end of the tubular wall 961. The barrel wall 11 has a slotted hole 116 formed proximate to the nozzle end 113 and in spatial communication with the barrel space 115, and a guide rail 117 disposed on the inner barrel surface 111 to define a portion of the chain moving track for movement of the transmission chain 71. An annular cap 97 is mounted on the nozzle end 113 of the barrel wall 11 to retain the rigid tube 96 in the barrel space 115 with the nozzle 963 projecting forwardly from the nozzle end 113. The base seat 962 is movable forwardly and in the expelling direction (D1) by the pressing member 72 to expel the fluid material 960 out of the nozzle 963. The rigid tube 96 is convenient to be replaced when the fluid material therein is entirely expelled.

As illustrated, with the transmission chain 71 wholly accommodated in the barrel 1, the length of the glue gun device is reduced to facilitate the workability and operability. The dispensing of a fluid material by the glue gun device is smooth even in terms of fastening, modeling, repairing, sealing and joining works. Moreover, with the triggering unit 4 operable to stepwise reach two operating positions in a triggering stroke, and with the clutch mechanism 64 able to be driven to move between the engaging and disengaging positions, the pressure on the fluid material can be released to prevent outflow of the fluid material when the trigger force on the triggering unit 4 is released.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A glue gun device for dispensing a fluid material, comprising:
a barrel having a barrel wall which defines a barrel space for receiving the fluid material, and which has a nozzle end and a driving end opposite to each other in an axial direction;
an outer casing having a rear housing portion which is connected with and extends rearwardly from said driving end in the axial direction;
a driving unit disposed within said rear housing portion;
a pressing unit disposed in said barrel, and including a pressing member which is movable relative to an inner barrel surface of said barrel wall in the axial direction to expel the fluid material out of said nozzle end, and a transmission chain which has a leading end that is connected to said pressing member to be operable to move said pressing member in the axial direction, and which is configured to extend from said leading end rearwardly and in the axial direction, be deflected downwardly at said driving end, and extend forwardly and in the axial direction to terminate at a trailing end, so as to define a chain moving track along an extension path of said transmission chain; and
a drive transmission unit disposed at said driving end and coupled with said driving unit to transmit a drive from said driving unit to said transmission chain so as to move said transmission chain along the chain moving track toward said nozzle end.

2. The glue gun device as claimed in claim 1, wherein said transmission chain is in the form of a unidirectional bending chain which is bent to match with said inner barrel surface of said barrel wall at said driving end.

3. The glue gun device as claimed in claim 1, wherein said barrel has a rail channel formed on said barrel wall and extending forwardly and in the axial direction from said driving end to define a portion of the chain moving track and for receiving a portion of said transmission chain proximate to said trailing end.

4. The glue gun device as claimed in claim 3, further comprising a handle which is connected to said trailing end and projects outwardly of said rail channel to be operable to move said transmission chain backwardly along the chain moving track so as to move said pressing member toward said driving end.

5. The glue gun device as claimed in claim 3, wherein said pressing member is in a spline engagement with said inner barrel surface of said barrel wall to prevent rotation of said pressing member relative to said barrel wall.

6. The glue gun device as claimed in claim 4, wherein said pressing member has an end wall which is disposed normal to the axial direction, a surrounding wall which extends rearwardly and in the axial direction from a periphery of said end wall, a retaining notch which is formed in said surrounding wall and recessed toward said end wall for retaining said leading end of said transmission chain therein, and a stabilizing portion which is disposed on said end wall and diametrically opposite to said retaining notch and extends adjacent to a center line of said end wall, said pressing unit further including a force dispersing member which interconnects said leading end and said stabilizing portion to disperse a force subjected to said retaining notch throughout said end wall.

7. The glue gun device as claimed in claim 1, wherein said drive transmission unit includes a chain wheel assembly meshing with said transmission chain and rotatable about a spindle axis that is transverse to the axial direction to move said transmission chain along the chain moving track, a first gear coupled to rotate with said driving unit, a second gear rotatably mounted on said chain wheel assembly about the spindle axis and meshing with said first gear, and a clutch mechanism axially movably mounted on said chain wheel assembly and operably movable along the spindle axis between an engaging position, where said clutch mechanism is engaged with both said chain wheel assembly and said second gear to permit transmission of the drive to rotate said chain wheel assembly, and a disengaging position, where said clutch mechanism is disengaged from both said chain wheel assembly and said second gear to interrupt the transmission of the drive.

8. The glue gun device as claimed in claim 7, wherein said chain wheel assembly has a spindle which extends along the spindle axis and on which said second gear is rotatably sleeved, and a chain wheel which is securely mounted on said spindle, said clutch mechanism being movably sleeved around said spindle.

9. The glue gun device as claimed in claim 8, wherein said spindle has a spindle body extending along the spindle axis, and an elongated key projecting from an outer surface of said spindle body and elongated in a direction transverse to the axial direction, said second gear having a gear portion which is rotatably mounted on said spindle body, and a first engaging portion which extends from said gear portion in the direction transverse to the axial direction toward said clutch mechanism, said clutch mechanism having a keyway and a second engaging portion which are configured to be engaged with said key and said first engaging portion, respectively, when said clutch mechanism is moved axially to the engaging position.

10. The glue gun device as claimed in claim 7, wherein said outer casing has a handheld housing portion which is connected with and extends downwardly from said rear housing portion, said glue gun device further comprising a triggering unit which is disposed within said handheld housing portion, said triggering unit including a contact switch which is electrically connected with said driving unit, an actuating arm, which is connected to said clutch mechanism, and a trigger which is disposed to be manually operable in a triggering stroke to a first operating position, where said trigger presses said contact switch to apply a power to said driving unit, and further to a second operating position, where said trigger presses said actuating arm to move said clutch mechanism to the engaging position.
